(19) United States
(12) Patent Application Publication
(10) Pub. No.: US 2018/0014520 A1
(43) Pub. Date: Jan. 18, 2018

(54) Container for Storing Jerk Bait Fishing Lure

(71) Applicant: Mafia Outdoors, LLC, Russellville, AR (US)

(72) Inventors: J. Barton Langley, Russellville, AR (US); Jeremy S. Starks, Scott Depot, WV (US)

(21) Appl. No.: 15/644,557

(22) Filed: Jul. 7, 2017

Related U.S. Application Data
(60) Provisional application No. 62/361,911, filed on Jul. 13, 2016.

(51) Int. Cl. A01K 97/06; B65D 21/02; B65D 43/16; B65D 43/22

(52) U.S. Cl. CPC A01K 97/06; B65D 43/22; B65D 21/0201; B65D 43/163

(57) ABSTRACT

A durable and waterproof jerk bait storage container having a number of individual cylindrical tubes with internal compartments joined together in offset rows such that each cylindrical tube can hold a jerk bait lure separately from other jerk bait lures. A lid is hingedly attached to the back row of cylindrical tubes to cover the cylindrical tubes.

### CROSS-REFERENCE TO RELATED APPLICATIONS

This application claims the benefit of U.S. Provisional Patent Application No. 62/361,911, entitled “Jerk Bait Storage Box” and filed on Jul. 13, 2016. The complete disclosure of said provisional application is hereby incorporated by reference.

### STATEMENT REGARDING FEDERALLY SPONSORED RESEARCH OR DEVELOPMENT

Not applicable

### BACKGROUND OF THE INVENTION

Recreational fishing is an activity enjoyed by tens of millions of people each year. In fact, some reports estimate that nearly forty-six million Americans participate in fishing activities in any given year. An average fishing participant is estimated to fish approximately 19.4 outings per year, with total combined fishing outings estimated at approximately 893 million times per year. While many of these fishermen cite the rush of catching a fish, the joys of the sights and sound of nature, and spending time with family as the best things about fishing, many fishermen say that one of the worst things about fishing is not having the right equipment.

Fishing tackle, a broad term used to refer to the equipment or gear used for catching fish, is essential for successful fishing. One popular fishing tackle is known as the “jerk bait,” which are particularly useful for catching bass. Jerk baits have characteristics that are similar to other lures and many times jerk baits have similar characteristics to crankbaits, which are also useful for bass fishing. Generally though, jerk baits may be characterized as being longer and more slender than other types of lures. While one main characteristic of jerk baits is that they are slender for their length, various styles and types of jerk baits exist, and different styles of jerk baits may be useful for different fishing situations. For example, different color jerk baits may be useful for a particular fishing situation based on the forage and weather conditions during that fishing situation. The appropriate color of a jerk bait may also be based on the water clarity and light conditions at that particular time. Because the best option for color or style of lure may be different on any given day (or even at different times throughout the same day), it is necessary for any avid fisherman to have a number of different jerk baits. For this reason, a storage box is a vital piece of equipment for anyone who engages in fishing activities.

The current box for jerk bait storage is a standard plastic tackle box. There is no way to keep the baits separate from one another, which results in baits constantly in contact with one another. This damages expensive baits and results in tangled hooks. Furthermore, other boxes offer little protection from moisture which causes hooks to rust. Finally, current storage boxes must be removed from a stowed position in order to gain access to the baits. An improved jerk bait storage container is desired for reducing or eliminating tangling, damaging, and rusting of jerk bait lures.

### BRIEF DESCRIPTION OF THE DRAWINGS

FIG. 1 is a perspective view of the jerk bait storage container of the present invention in the closed position.

FIG. 2 is a top view of the jerk bait storage container of the present invention in the closed position.

FIG. 3 is a side view of the jerk bait storage container of the present invention in the closed position.

FIG. 4 is an end view of the jerk bait storage container of the present invention in the closed position.

FIG. 5 is a perspective view of on embodiment of the jerk bait storage container of the present invention in a closed position.

FIG. 6 is a perspective view of one embodiment of the jerk bait storage container of the present invention in an open position.

### DETAILED DESCRIPTION OF THE INVENTION

The present invention is directed to fishing products and more particularly to a durable storage container for holding a quantity of fishing lures. While the preferred embodiment of the present invention is configured to store jerk bait style fishing lures, it is understood that any variety of baits may be used with the storage container described herein.

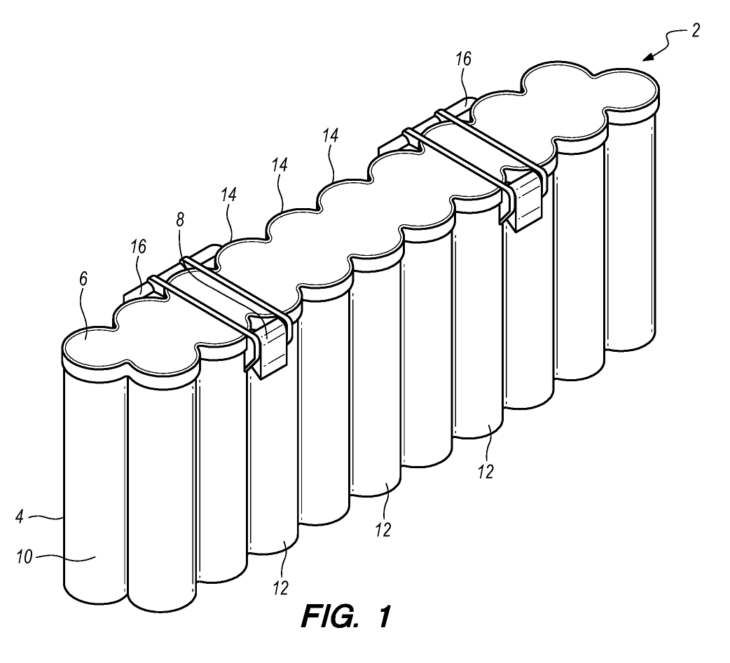

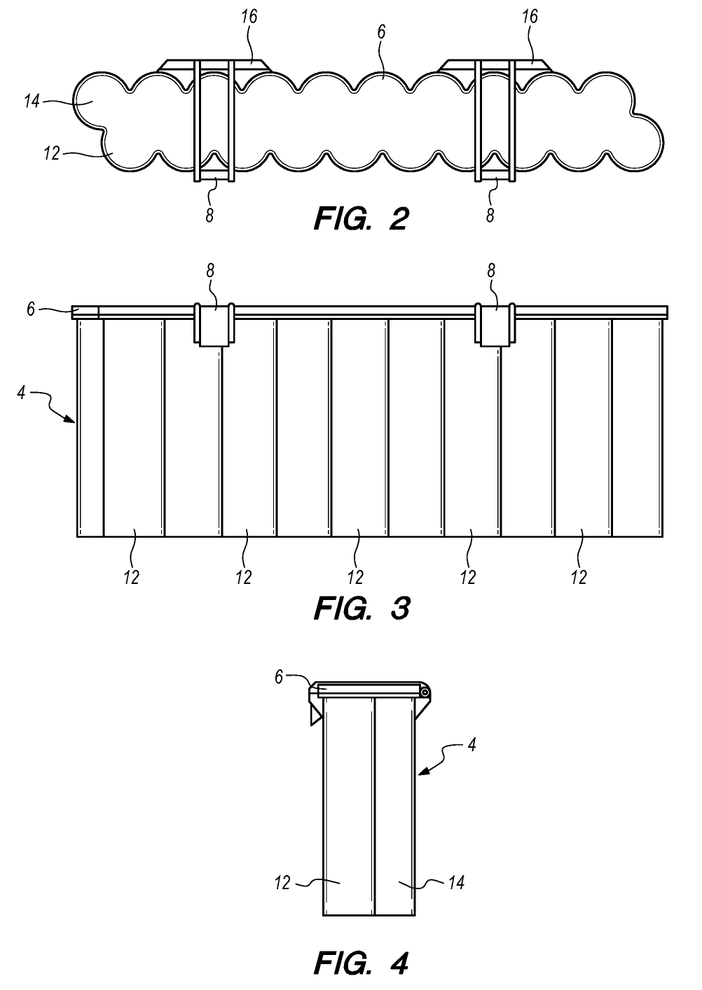

With reference to FIGS. 1-6, the preferred embodiments of the jerk bait storage container of the present invention may be described. The storage container 2 is made up of a bottom compartment section 4 and a lid 6. The compartment section 4 is generally made up of a number of joined cylindrical tubes 10 in a front row 12 and a back row 14, which are described more fully below. The tubes 10 have hollow internal storage compartments that are configured to receive a jerk bait or other lure in an upright, vertical position. Each tube 10 is configured to hold a single bait, which keeps baits separate from one another, preventing damage to the finishes of the baits. In addition, because each tube 10 stores an individual fishing bait, the baits stored in the entire container 2 do not become tangled with one another. Finally, the tubular design adds strength and conserves storage space. This allows the user to access the container 2 even when the container 2 is in a stowed position on a boat.

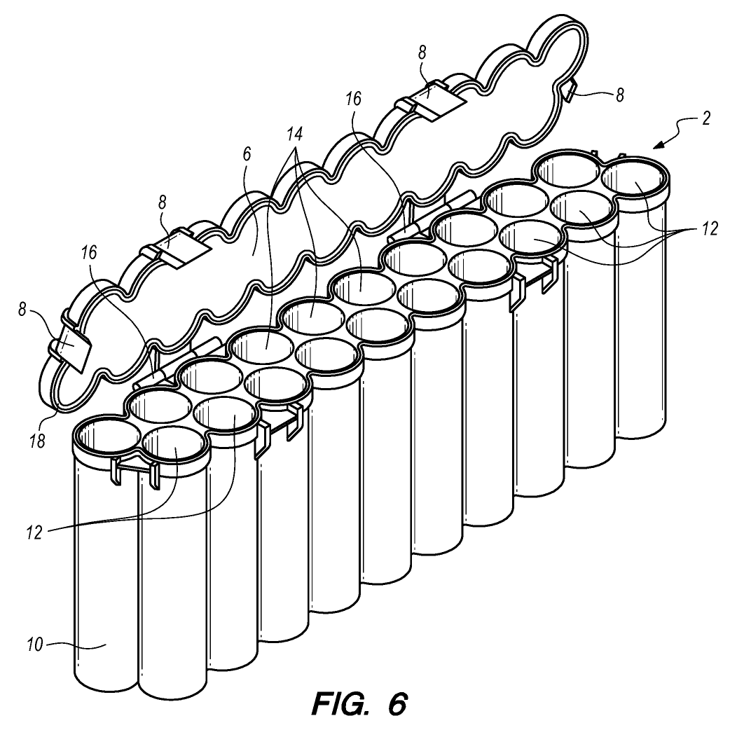

As discussed above, the compartment section 4 is made up of a number of cylindrical tubes 10 joined together to form a storage container 2 having multiple storage compartments, as each cylindrical tube 10 serves as a storage compartment for a single jerk bait or other lure. More specifically, each tube 10 has side walls, some of which are shared by other tubes 10 and some of which act as an outer wall of the entire storage compartment 4. Each cylindrical tube 10 also has a bottom surface connected to the side walls to form a hollow internal compartment configured to receive the jerk bait, lure, or other fishing product. In the preferred embodiment, the compartment section 4 is made up of two rows 12, 14 of cylindrical tubes 10, with the front row 12 being offset from the backrow 14 such that the tubes 10 of one row align such that they are positioned adjacent to and between the tubes of other row, as shown more clearly in FIGS. 2 and 6.

While the preferred embodiment has ten tubes 10 in the front row 12 and ten tubes 10 in the back row 14, which provides a long and narrow storage container 2 perfect for fitting into the storage compartment of a boat, the number of tubes, number of rows, or size of tubes may all be modified to meet various fishing needs. For example, the tubes 10 may be positioned in more rows with fewer tubes 10 in each row to provide a square shape container. Likewise, although in the preferred embodiment the cylindrical tubes are approximately 6.5 inches in height, the height of the cylindrical tubes may be modified in order to hold different size baits. Other shapes and sizes may be implemented, but it is understood that the advantages of the present invention are especially realized with the shape and size of the preferred embodiment.

The lid 6 of the storage container 2 acts as the top surface of the storage container 2, which allows the storage container 2 to be transported without losing the contents of the tubes 10. The lid 6 has a sealing ring 18, as shown in FIG. 6, which is used to create a water-tight seal when the lid 6 is closed. This creates a waterproof storage container 2 when the lid 6 is closed, which ultimately serves to keep the baits free of rust. One embodiment of the storage container 2 has a lip on the upper portion of the outer walls of tubes 10 of the compartment section 4. The lid 6 and sealing ring 18 on the inside of the outer edges of the lid 6 are configured to fit securely around this lip which further facilitates waterproofing of the container 2.

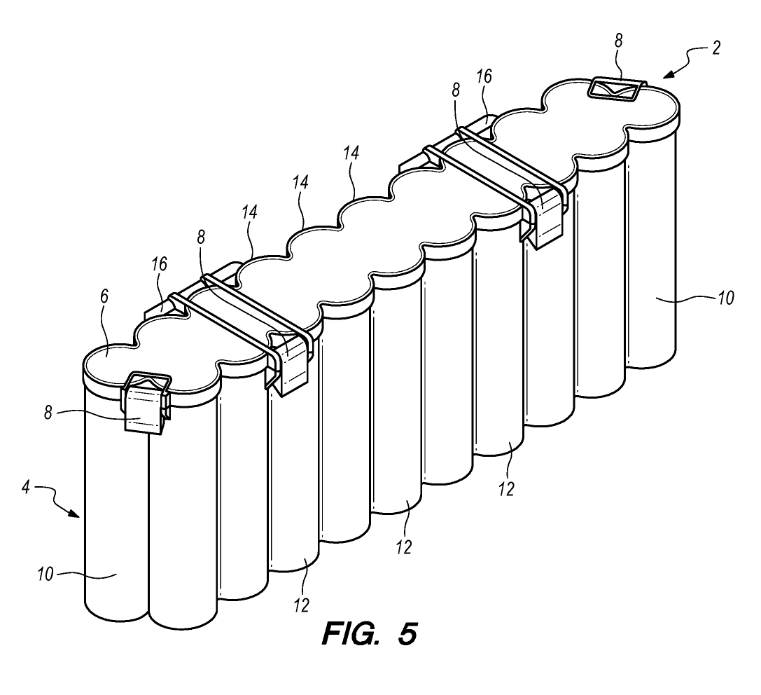

The storage container 2 is preferably created from an acrylonitrile butadiene styrene (ABS) materiel that is extremely durable and crush resistant. This not only provides a strong and durable container, but also allows the container to float. In the preferred embodiment, the lid 6 is hingedly connected to the storage compartment 4. Specifically, the lid 6 is hingedly attached using a set of hinges 16 that connect the lid 6 to the outside walls of tubes 10 at opposite ends of the back row 14 of tubes 10. This allows the lid 6 to be opened and closed while remaining connected to the storage compartment section 4 of the storage container 2. A set of latches 8 is attached to the lid 6 so that the lid 6 may be secured in the closed position by connecting the latches 8 to their counterparts on the front row 12 of tubes 10 of the storage container 2. In one embodiment additional latches 8 are implemented on opposite ends of the storage compartment 4, with the latches 8 being situated between the rows of tubes 12, 14, as shown in FIGS. 5-6.

The present invention has been described with reference to certain preferred and alternative embodiments that are intended to be exemplary only and not limiting to the full scope of the present invention.

We claim:

1. A storage container for fishing lures comprising:
a. a first row of cylindrical tubes joined side-by-side;
b. a second row of cylindrical tubes joined side-by-side, wherein the second row of cylindrical tubes is connected to the first row of cylindrical tubes; and
c. a lid configured to cover the first row of cylindrical tubes and the second row of cylindrical tubes.

2. The storage container of claim 1, wherein the first row of cylindrical tubes is offset from the second row of cylindrical tubes.

3. The storage container of claim 1, wherein the cylindrical tubes in the first row and the second row are configured to hold jerk baits.

4. The storage container of claim 1, wherein the lid is hingedly attached to the first row of cylindrical tubes.

5. The storage container of claim 1, further comprising a latch.
